(19) United States
(12) Patent Application Publication
(10) Pub. No.: US 2026/0178070 A1
(43) Pub. Date: Jun. 25, 2026

(54) LOOKUP TABLE ACCESS FOR QUANTIZATION AND DEQUANTIZATION OPERATIONS

(71) Applicant: Advanced Micro Devices, Inc., Santa Clara, CA (US)

(72) Inventors: Shubra Marwaha, Santa Clara, CA (US); Bin He, Orlando, FL (US); Subramaniam Maiyuran, Folsom, CA (US)

(21) Appl. No.: 18/999,426

(22) Filed: Dec. 23, 2024

(51) Int. Cl. G06F 1/03; G06F 12/02

(52) U.S. Cl. CPC G06F 1/03; G06F 12/0207

(57) ABSTRACT

One or more cache lines are configured to store a lookup table (LUT) having a plurality of floating-point numbers that are represented by a first number of bits. One or more multiplexers are connected to the cache line(s). The multiplexer(s) is/are configured to select one of the floating-point numbers based on an integer index having a second number of bits that is less than the first number of bits. The integer index is a quantized representation of the selected one of the floating-point numbers. In some cases, a memory is configured to store a matrix of integer indices that are generated by quantizing floating-point numbers that represent data associated with a machine learning algorithm. The integer index is provided by the matrix of the integer indices.

### BACKGROUND

Machine learning (ML) algorithms (including artificial intelligence (AI) algorithms) typically operate on very large datasets. For example, training an ML model to perform one or more tasks can require performing operations on hundreds or thousands or millions of matrices of data, which is typically represented in a 32-bit floating-point format. The resources required to process these data sets can be reduced by converting or dequantizing the data so that it is represented with a smaller number of bits. For example, data in a 32-bit format can be converted to an eight-bit format, a six-bit format, or a four-bit format. Conventional quantization or dequantization algorithms convert numbers between different formats using mathematical functions and parameters such as a scale and a bias. Thus, every quantization or dequantization operation consumes resources of the processing system. The processing overhead for these conversions becomes significant for ML algorithms that are operating on very large datasets.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that uses an LUT to perform conversion or dequantization of integer indexes that represent quantized floating-point numbers, according to some embodiments.

FIG. 2 illustrates a portion of a system for generating an LUT, according to some embodiments.

FIG. 3 illustrates a portion of a processing system that supports quantization or dequantization using an LUT, according to some embodiments.

FIG. 4 illustrates a portion of a processing system that performs the conversion or dequantization of a tensor using an LUT, according to some embodiments.

FIG. 5 illustrates a method of quantizing tensor data, according to some embodiments.

FIG. 6 illustrates a method of converting or dequantizing tensor data using a single instruction and an LUT, according to some embodiments.

### DETAILED DESCRIPTION

The computational overhead of conversion operations including quantization and dequantization can be reduced by representing quantized numbers as indices into a matrix of entries that store dequantized values corresponding to the indices. For example, an 8-bit floating-point number can be represented as a 4-bit integer index that indicates an entry in a lookup table (LUT) that stores the 8-bit floating-point number or an 8-bit floating point number that approximates the original value. Quantizing the 8-bit floating point number as a 4-bit integer index reduces the storage and bandwidth requirements of the quantized data, e.g., reducing the size of a matrix of data by half. However, operations such as matrix multiplication cannot be performed on data that is converted or quantized into a 4-bit integer index into an LUT because multiplying the two integer indices does not produce a third index that points to an entry in the LUT that stores a value equal to the product of the floating-point numbers stored in the entries indicated by the two indices. Conversion of the 4-bit integer representation of the floating-point number is performed by accessing the LUT instead of performing a mathematical operation, which reduces the computational overhead.

The architecture of a conventional processing system is typically configured based on the expected formats of data that are operated on by the processing system. For example, floating-point numbers can be represented using a 32-bit format. Cache lines in the processing system are therefore configured to hold 32 bits, 64 bits, or more so that data in 32-bit formats can be stored in each cache line. Consequently, selecting a 4-bit index (sometimes referred to herein as a “nibble”) requires a relatively complicated set of instructions. For example, a 32-bit shifter can be used to emulate a 4-bit nibble by shifting the desired four bits to one end of the shifter, zero-padding the remaining bits, and then using a series of “and” operations to read the bits. Thus, emulating the 4-bit nibble in a conventional architecture increases the computational overhead for operations such as conversion or dequantization of floating-point numbers using an LUT.

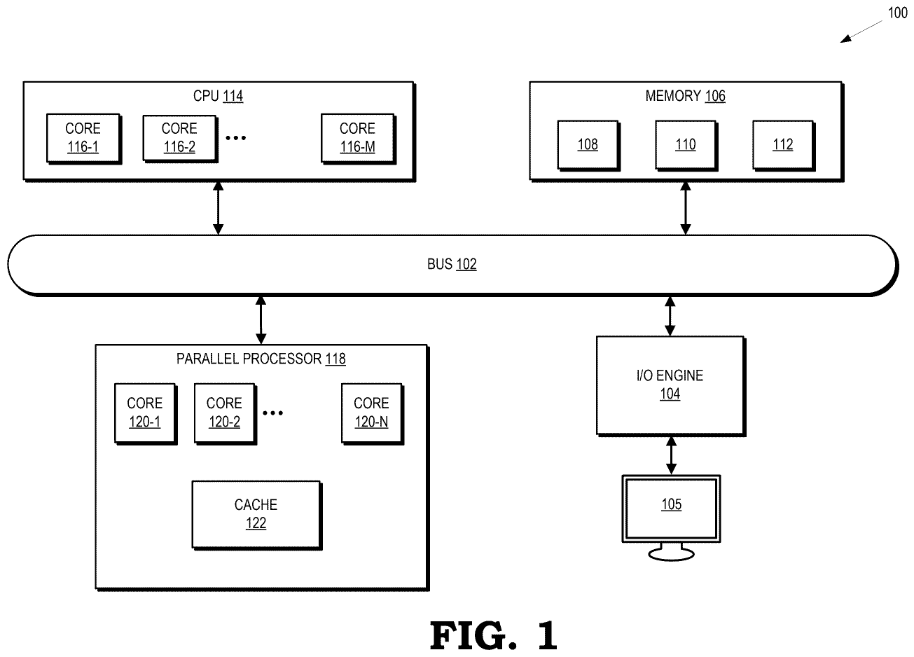

FIGS. 1-6 illustrate systems, apparatuses, and methods of improving the performance of a processing system that implements quantization or dequantization operations to convert data between different formats with an LUT. The system or apparatus includes a hierarchy of multiplexers that are organized to select portions of one or more cache lines based on an index that is represented as multiple bits. In some embodiments, the index is represented as four bits. The LUT is generated using a quantization algorithm that maps indices corresponding to entries in the LUT to values stored in the entries of the LUT. The number of multiplexers in the hierarchy is determined based on the number of bits used to represent data in the quantized format. In some embodiments, the hierarchy includes a first level of multiplexers that are indexed using a first subset of the bits and a second level of multiplexers that are indexed using a second subset of the bits. For example, if four bits are used to represent quantized data, two multiplexers in a first level of the hierarchy can be used to select two entries from the one or more cache lines based on three of the bits in the index, and a fourth bit from the index is used to select between the two entries. The number of cache lines connected to the multiplexers is determined based on the number of bits used to represent data in the original format and the quantized format. For example, two 64-bit cache lines are used to cache 16 entries from the LUT if data has been converted from an 8-bit floating point format to a 4-bit integer index format. For another example, two 48-bit cache lines are used to cache 16 entries from the LUT if data has been converted from a 6-bit floating point format to a 4-bit integer index format. For yet another example, two 32-bit cache lines are used to cache 16 entries from the LUT if data has been converted from a 4-bit floating point format to a 4-bit integer index format. Matching the multiplexer hierarchy to the size of the cache lines needed to store the LUT when retrieved from memory allows conversion or dequantization to be performed using a single instruction.

FIG. 1 is a block diagram of a processing system 100 that uses an LUT to perform conversion or dequantization of integer indexes that represent quantized floating-point numbers, according to some embodiments. The processing system 100 includes a bus 102 implemented with circuitry that supports communication between entities implemented in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 105, as well as other elements of the processing system 100 such as keyboards, mice, printers, external disks, and the like. The I/O engine 104 is coupled to the bus 102 so that the I/O engine 104 can communicate with other entities in the processing system 100 by exchanging signals over the bus 102.

Processing system 100 also includes or has access to a memory 106 or other storage component implemented using a non-transitory computer-readable medium such as a dynamic random-access memory (DRAM). However, some embodiments of the memory 106 are implemented using other types of memory including, for example, static random-access memory (SRAM), nonvolatile RAM, and the like. Some embodiments of the memory 106 include an external memory implemented external to the processing units implemented in the processing system 100. The memory 106 can store information representing instructions such as program code 108 for one or more applications (e.g., graphics applications, compute applications, machine learning applications), data 110 that is consumed by the program code 108, and results 112 produced by executing the program code 108.

The processing system 100 includes a central processing unit (CPU) 114 that is connected to the bus 102 to communicate with other entities in the processing system 100, such as the I/O engine 104, the memory 106, or other entities connected to the bus 102. The CPU 114 is implemented with circuitry including a plurality of processor cores 116-1, 116-2, . . . 116-N that execute instructions concurrently or in parallel. Although three processor cores 116 are shown in FIG. 1, more or fewer processor cores 116 can be implemented in other embodiments of the CPU 114. The processor cores 116 include circuitry to implement one or more compute units such as single-instruction, multiple data (SIMD) units that perform the same operation on different data sets to produce one or more results. The CPU 114 is configured to execute instructions such as the program code 108 for one or more applications (e.g., graphics applications, compute applications, machine learning applications), which is stored in the memory 106. The CPU 114 can consume data 110 and store information in the memory 106 such as the results 112 of the executed instructions.

The processing system 100 also includes a parallel processor 118. The parallel processor 118 can include, for example, a GPU, a general-purpose GPU (GPGPU), a neural processing unit (NPU), an intelligence processing unit (IPU) or other vector processor or type of parallel processor. The parallel processor 118 includes circuitry to implement one or more processor cores 120-1 . . . M that each operate as a compute unit configured to perform one or more operations based on one or more instructions received by the parallel processor 118. Although three processor cores 120 are shown in FIG. 1, more or fewer processor cores 120 can be implemented in other embodiments of the parallel processor 118. The compute units in the processor cores 120 are implemented as circuitry for one or more single-instruction, multiple data (SIMD) units that perform the same operation on different data sets to produce one or more results.

In the illustrated embodiment, the parallel processor 118 also includes one or more caches 122 that are used to cache frequently used instructions or data, which can be retrieved or fetched from the memory 106. For example, instructions can be fetched from the program code 108 and stored in an instruction cache in the caches 122; data can be fetched from the data 110 and stored in a data cache in the caches 122. Although the caches 122 are shown external to the processor cores 120, some embodiments of the processor cores 120 include additional, internal caches. The caches 122 (or internal caches, if present) include one or more cache lines configured to store a lookup table (LUT) that includes entries for a plurality of floating-point numbers, such as floating-point numbers that are used to represent data used to train ML models or to implement or use the ML models. The floating-point numbers are represented by a predetermined number of bits, such as 32 bits to represent the numbers in FP 32 format, sixteen bits to represent numbers in FP16 format, eight bits to represent numbers in FP8 format, six bits to represent numbers in FP6 format, or four bits to represent numbers in FP4 format. As discussed herein, a set of multiplexers can be connected to the cache lines and used to select one of the floating-point numbers based on an integer index. In some embodiments, the integer index is a quantized representation of a floating-point number and the quantized representation uses a smaller or equal number of bits than the number of bits used to represent the floating-point number.

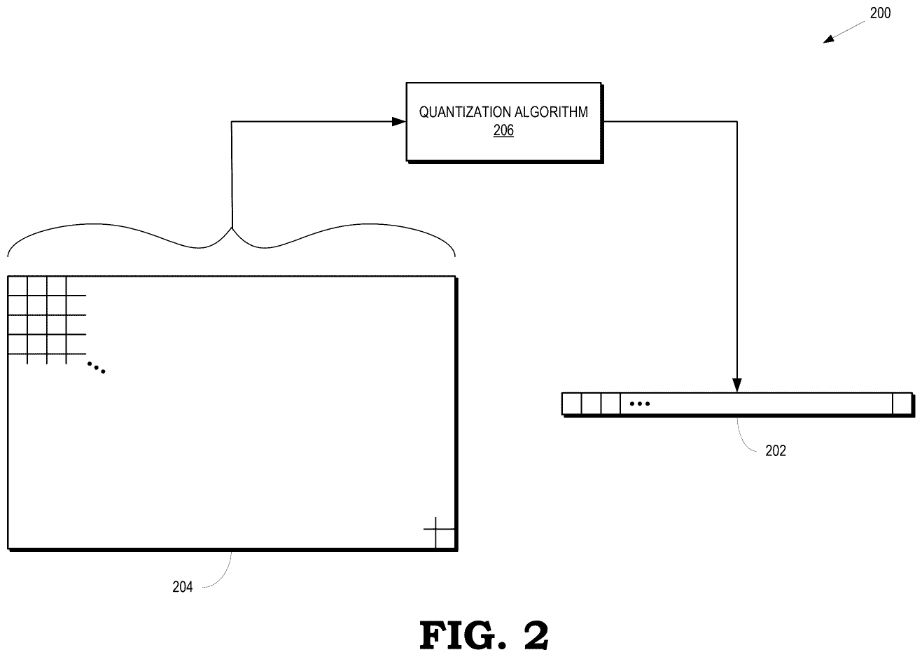

FIG. 2 illustrates a portion 200 of a system for generating a lookup table (LUT) 202, according to some embodiments. The portion 200 of the system can be implemented in some embodiments of the processing system 100 shown in FIG. 1 can be used to generate an LUT 202 that is used to convert or dequantize integer indices that represent quantized floating-point numbers, as discussed herein.

In the illustrated embodiment, one or more data sets are stored as one or more matrices 204. For example, the matrix 204 can be used to store data that is used to train an ML model. Entries in the matrix 204 include bits that represent floating-point numbers in a predetermined format that utilizes a predetermined number of bits to represent the floating-point numbers, e.g., 32 bits can be used to represent the numbers in FP 32 format, sixteen bits can be used to represent numbers in FP16 format, etc.

A quantization algorithm 206 accesses data in the matrix 204 (or other matrices) and uses the data to generate the LUT 202. Entries in the LUT 202 include floating-point numbers in the predetermined format that are mapped to the indices of the entries. For example, the LUT 202 can include sixteen entries that are identified by 4-bit indices. The quantization algorithm 206 maps the indices for the entries of the LUT 202 to the floating-point numbers that are stored in the entries of the LUT 202. The algorithm implemented by the quantization algorithm 206 is a matter of design choice and can consider factors such as a range of values of the floating-point numbers in the entries of the matrix 204, a distribution of the values of the floating-point numbers in the entries of the matrix 204, outliers from the distribution of the values, and the like. The LUT 202 can then be used to quantize or dequantize floating-point numbers, as discussed herein.

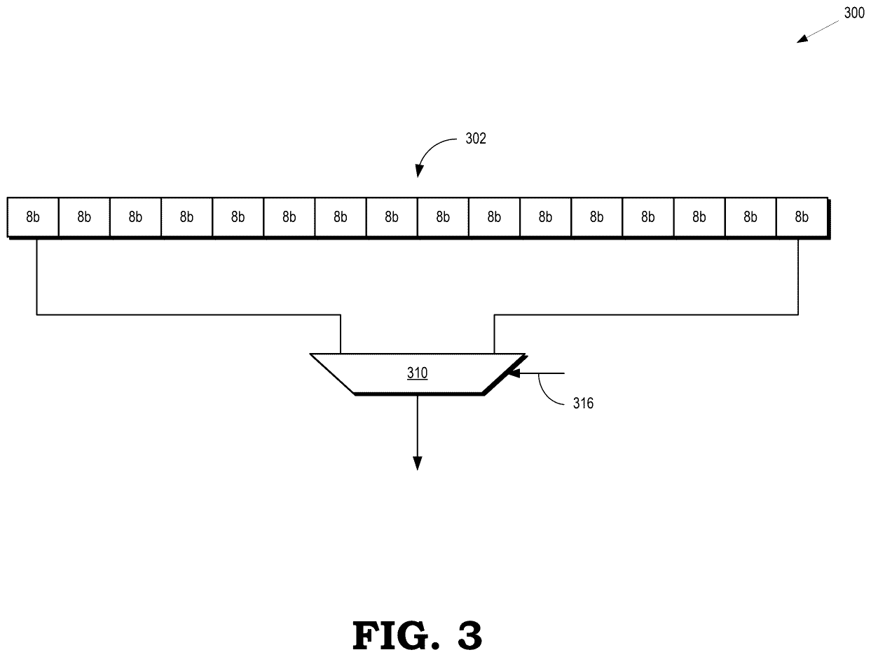

FIG. 3 illustrates a portion 300 of a processing system that supports quantization or dequantization using an LUT, according to some embodiments. The portion 300 can be implemented in some embodiments of the processing system 100 shown in FIG. 1.

The portion 300 implements a cache (such as the cache 122 shown in FIG. 1) that includes a set of cache lines to store entries from an LUT such as the LUT 202 shown in FIG. 2. The entries in the LUT hold values of floating-point numbers corresponding to integer indices that identify the entries. As discussed herein, the integer indices represent quantized values of the floating-point numbers. The floating-point numbers are represented by a first number of bits and the integer indices are represented by a second number of bits, which is less than or equal to the first number of bits. The first number is therefore equal to or larger than the second number. The number of cache lines in the set is determined based on the first number of bits and the second number of bits. In the illustrated embodiment, the floating-point numbers are represented in an 8-bit format and the integer indices are represented in a 4-bit format. Thus, in the illustrated embodiment, the set of cache lines includes a 128-bit cache line 302 that is configured to store the entries of the LUT. However, additional cache lines having more or fewer entries that are larger or smaller that eight bits can be implemented in other embodiments.

A hierarchy of multiplexers is used to select an access entries in the LUT from the cache line 302 based on selection signals generated or derived using the integer indices. In the illustrated embodiment, the hierarchy includes a multiplexer 310. However, in other embodiments, the hierarchy includes additional multiplexers that are interconnected to form a plurality of levels. The number of multiplexers in the hierarchy can be determined based on the second number of bits used to represent the integer indices. In the illustrated embodiment, the multiplexer is indexed using a selection signal 316 that is generated based on the bits that represent the integer index. However, if the hierarchy includes additional levels that require multiple selection signals, the different selection signals are determined based on different subsets of the bits. For example, if there are two levels in the hierarchy, multiplexers in a first level of the hierarchy are indexed using a first subset of the bits that represent the integer index and a second level of multiplexers are indexed using a different, second subset of the bits that represent the integer index. The selection signal 316 is provided or asserted to the multiplexer 310 to select between the entries of the cache line 302.

Although the illustrated embodiment of the portion 300 includes the cache lines 302 that is used to store 8-bit representations of floating-point numbers, some embodiments of the portion 300 implement cache lines of different sizes to store different floating-point formats that use different numbers of bits. For example, if the floating-point numbers are represented using six bits and the integer index is represented using four bits, the cache line 302 can be implemented using a 96-bit cache line. For another example, if the floating-point numbers are represented using four bits and the integer index is represented using four bits, the cache line 302 can be implemented using a 64-bit cache line. More or fewer cache lines can be implemented in some embodiments, as well as more or fewer levels in the multiplexer hierarchy and more or fewer multiplexers.

The architecture of the portion 300 of the processing system allows conversion or dequantization of tensors to be performed using a single instruction. For example, a single instruction can be used to convert or dequantize a tensor format from a quantized integer representation to a floating-point format that uses eight bits. The instruction can copy or fetch or store a first matrix representing the tensor including the quantized integer values into a local memory. The instruction can also copy or fetch or store the LUT that represents the mapping of the integer indices to floating-point values into the cache line 302. Executing the instruction generates a second matrix representing the tensor including the dequantized floating-point values. The second matrix can be stored locally or in other memory.

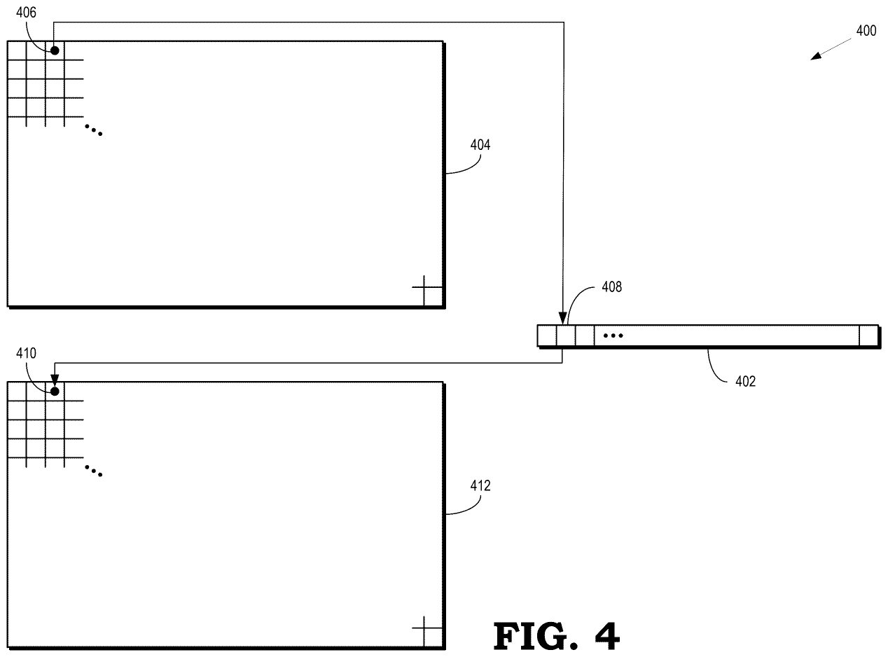

FIG. 4 illustrates a portion 400 of a processing system that performs the conversion or dequantization of a tensor using an LUT 402, according to some embodiments. In the illustrated embodiment, the tensor is stored as a matrix 404 and entries in the matrix 404 include 4-bit representations of integer indices that are generated by quantizing floating-point data, such as floating-point data that is used by ML algorithms. To perform the conversion or dequantization, the processing system accesses the entries (such as the entry 406) in the matrix 404 to retrieve the value of the 4-bit integer index that represents the quantized floating-point data for this element of the tensor. The integer index is used to generate a selection signal to select a corresponding entry 408 in the LUT 402, e.g., using a hierarchy of multiplexers such as the multiplexer 310 shown in FIG. 3. The floating-point value stored in the entry 408 is then written to the appropriate entry 410 in a matrix 412 that represents the converted or dequantized tensor.

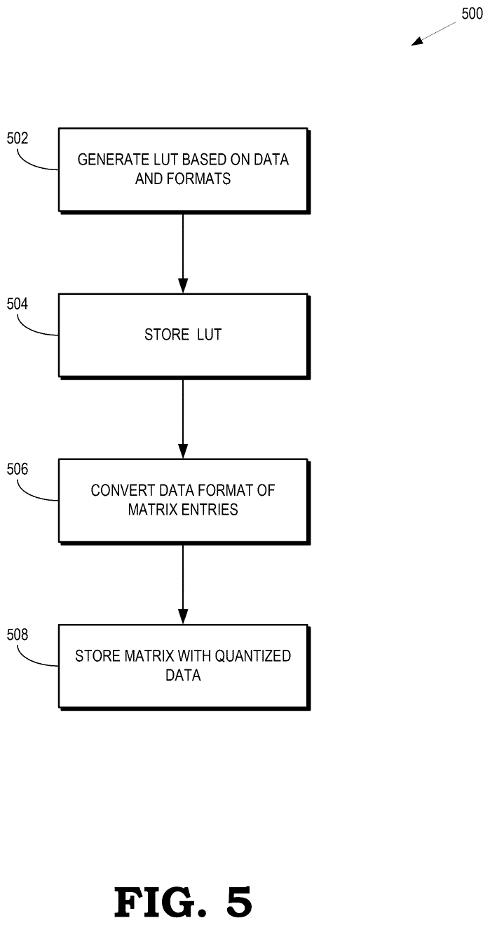

FIG. 5 illustrates a method 500 of quantizing tensor data, according to some embodiments. The method 500 is implemented in some embodiments of the processing system 100 shown in FIG. 1.

At block 502, the processing system generates an LUT based on data and the formats of the original data and the quantized data. In some embodiments, the data includes data in the tensor that is going to be quantized. The format of the original data is a floating-point format such as an 8-bit floating point format. The format of the quantized data is an integer format such as a 4-bit integer format. The LUT represents a mapping between the 4-bit integer indices into the LUT and 8-bit floating point values that are stored in the entries of the LUT. The algorithm used to determine the mapping of the 4-bit integer indices to the 8-bit floating point values is a matter of design choice.

At block 504, the processing system stores the LUT. In some embodiments, the LUT is stored in a memory such as the memory 106 in the processing system 100 shown in FIG. 1.

At block 506, the processing system converts or quantizes data in the entries of a matrix that represents the tensor data. For example, the processing system can access the entries in the matrix to retrieve the original floating-point values and then the processing system can convert or quantize the floating-point values into the integer indices using the quantization algorithm and/or the LUT.

At block 508, the processing system stores the matrix including the quantized data. In some embodiments, the matrix of quantized data is stored in a memory such as the memory 106 in the processing system 100 shown in FIG. 1. Quantizing the floating-point values of the tensor data reduces the bandwidth storage requirements for the tensor data.

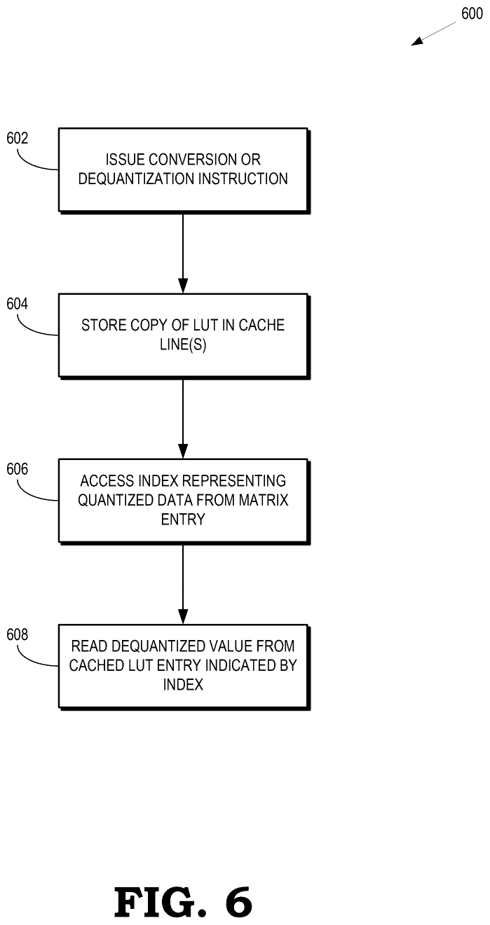

FIG. 6 illustrates a method 600 of converting or dequantizing tensor data using a single instruction and an LUT, according to some embodiments. The method 600 is implemented in some embodiments of the processing system 100 shown in FIG. 1.

At block 602, a conversion or dequantization instruction is issued. As discussed herein, the instruction can include arguments indicating a location of a source matrix including the quantized tensor data, a location of an LUT that represents a mapping of quantized integer indices to dequantized floating-point tensor data, and the location of a destination matrix that holds the dequantized tensor data. Different instructions can be defined and used to perform conversion quantization between different floating-point formats and formats for the integer indices.

At block 604, a copy of the LUT is retrieved or fetched from memory and stored in a set of cache lines. As discussed herein, the cache lines are interconnected with a hierarchy of multiplexers that are configured to select elements from the cache lines in response to selection signals that are generated based on values of the integer indices stored in the source matrix.

At block 606, integer indices are accessed from the entries of the source matrix. The integer indices can be accessed sequentially, randomly, or concurrently in different embodiments.

At block 608, the dequantized floating-point values are read from entries in the LUT that are indicated by the integer indices. The dequantized floating-point values are then written to the appropriate entries in the destination matrix.

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is set forth in the claims below.

What is claimed is:

1. An apparatus comprising:
a cache comprising at least one cache line configured to store a lookup table (LUT) having a plurality of floating-point numbers that are represented by a first number of bits; and
at least one multiplexer connected to the cache, wherein the at least one multiplexer is configured to select one of the plurality of floating-point numbers based on an integer index having a second number of bits that is less than the first number of bits, and wherein the integer index is a quantized representation of the selected one of the plurality of floating-point numbers.

2. The apparatus of claim 1, further comprising:
a memory configured to store a matrix of integer indices that are generated by quantizing floating-point numbers that represent data associated with an artificial intelligence or machine learning algorithm, and wherein the integer index is provided by the matrix of the integer indices.

3. The apparatus of claim 1, wherein the at least one multiplexer is organized as a hierarchy of multiplexers that are interconnected to form a plurality of levels.

4. The apparatus of claim 3, wherein a number of multiplexers in the hierarchy is based on the second number of bits.

5. The apparatus of claim 4, wherein the hierarchy comprises a first level of multiplexers that are indexed using a first subset of the bits that represent the integer index and a second level of multiplexers that are indexed using a second subset of the bits that represent the integer index.

6. The apparatus of claim 4, wherein a number of cache lines in the at least one cache line is determined based on the first number of bits and the second number of bits.

7. The apparatus of claim 6, wherein the first number of bits is eight and the second number of bits is four, and wherein the at least one cache line comprises two 64-bit cache lines.

8. The apparatus of claim 6, wherein the first number of bits is six and the second number of bits is four, and wherein the at least one cache line comprises two 48-bit cache lines.

9. The apparatus of claim 6, wherein the first number of bits is four and the second number of bits is four, and wherein the at least one cache line comprises two 32-bit cache lines.

10. A method comprising:
storing a lookup table (LUT) in at least one cache line of a processing system, the LUT having a plurality of floating-point numbers that are represented by a first number of bits;
generating selection signals based on based on an integer index having a second number of bits that is less than the first number of bits, wherein the integer index is a quantized representation of the selected one of the plurality of floating-point numbers; and
selecting one of the plurality of floating-point numbers by asserting the selection signals to at least one multiplexer connected to the at least one cache line.

11. The method of claim 10, wherein the at least one multiplexer is organized as a hierarchy of multiplexers that are interconnected to form a plurality of levels, and wherein generating the selection signals comprises generating selection signals for multiplexers in the plurality of levels based on different subsets of bits that represent the integer index.

12. The method of claim 11, wherein the hierarchy comprises a first level of multiplexers and a second level of multiplexers that receive input from the first level of multiplexers, and wherein generating the selection signals comprises generating a first subset of the selection signals for the first level of multiplexers based on a first subset of the bits that represent the integer index and generating a second subset of the selection signals for the second level of multiplexers based on a second subset of the bits that represent the integer index.

13. The method of claim 12, wherein selecting the one of the plurality of floating-point numbers comprises asserting the first subset of the selection signals to the first level of multiplexers and asserting the second subset of the selection signals to the second level of the multiplexers.

14. The method of claim 10, further comprising:
accessing, from a first matrix, a plurality of floating-point numbers that use the first number of bits to represent data associated with a machine learning algorithm.

15. The method of claim 14, further comprising:
quantizing the plurality of floating-point numbers to form a plurality of integer indices that represent the floating-point numbers with the second number of bits.

16. The method of claim 15, further comprising:
storing the plurality of integer indices in a second matrix.

17. The method of claim 16, further comprising:
dequantizing the plurality of integer indices in the second matrix using the LUT; and
storing dequantized values of the plurality of integer indices in a third matrix.

18. A method comprising:
accessing, from a first matrix, a plurality of integer indices that use a first number of bits to represent quantized data associated with a machine learning algorithm;
fetching a lookup table (LUT) into at least one cache line of a processing system, the LUT having a plurality of floating-point numbers that are represented by a second number of bits that is larger than the first number of bits; and
dequantizing the plurality of integer indices by asserting selection signals derived from the plurality of integer indices to at least one multiplexer connected to the at least one cache line.

19. The method of claim 18, further comprising:
generating the selection signals based on the plurality of integer indices; and
selecting one of the plurality of floating-point numbers from the LUT by asserting the selection signals to the at least one multiplexer.

20. The method of claim 19, further comprising:
storing dequantized values of the plurality of integer indices in a second matrix.
